(19) United States
(12) Patent Application Publication
(10) Pub. No.: US 2009/0085325 A1
(43) Pub. Date: Apr. 2, 2009

(54) Portable Stand for Power Tool

(76) Inventors: Robert E. McCracken, Anderson, SC (US); Scott Bettencourt, Greenville, SC (US); Wade F. Burch, Clemson, WI (US); William C. Buck, Clemson, SC (US); Thomas Parel, Anderson, SC (US); Andrew Valentine, Midlothian, VA (US); James A. Keith, JR., Pickens, SC (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/238,780

(22) Filed: Sep. 26, 2008

Related U.S. Application Data
(60) Provisional application No. 60/976,642, filed on Oct. 1, 2007.

(51) Int. Cl. B60D 1/00; B25H 1/00; B26D 1/157

(52) U.S. Cl. 280/415.1; 144/286.5; 83/471.3

(57) ABSTRACT

A portable stand for a work tool is provided. The portable stand includes a rigid member with a longitudinal axis and a connector configured to be releasably mounted to a vehicle. A first post extends from the rigid member and a frame is rotatably connected with the first post and fixable with respect to the first post in a plurality of discrete positions. A mounting bracket is lockingly engageable with the frame and configured to fixedly support a work tool.

### CROSS-REFERENCE TO RELATED APPLICATIONS

This application claims priority from U.S. Provisional Application No. 60/976,642 filed on Oct. 1, 2007, the entirety of which is fully incorporated herein by reference.

### TECHNICAL BACKGROUND

It is common in the construction industry for a user to bring tools to a worksite for the sake of convenience and efficiency. Many power tools, such as miter saws and the like are extremely heavy, which makes it prohibitive to carry these types of tool extended distances to a job site. Accordingly, it is common to mount power tools to a cart, foldable stand, or other type of transport apparatus to assist in moving a power tool to the job site. Many conventional carts or stands are foldable, but are relatively unwieldy and difficult to fold and unfold with a power tool attached. Additionally, many carts or stands do not include locking mechanisms for both the folded position and the unfolded position for using the power tool. Finally, while stands are often used to transport and support power tools, stands and the tools must be removed from a vehicle and set up after arrival at a construction site and taken down after the task is completed, which takes time and reduces the efficiency of completing the task.

### BRIEF SUMMARY

A first representative embodiment of the disclosure provides a portable stand for a work tool. The portable stand includes a rigid member with a longitudinal axis and a connector configured to be releasably mounted to a vehicle. A first post extends from the rigid member and a frame is rotatably connected with the first post and fixable with respect to the first post in a plurality of discrete positions. A mounting bracket is lockingly engageable with the frame and configured to fixedly support a work tool.

A second representative embodiment of the disclosure provides a portable stand for a tool. The portable stand includes a rigid member with a longitudinal axis, and additionally includes a connector for selective releasable connection with a vehicle. A plurality of wheels are rotatably mounted to the rigid member, and configured to allow the stand to be transported when not mounted to the vehicle. A first post and a second post each extend substantially perpendicularly from opposite ends of the rigid member. A first frame and a second frame are each mounted to the respective first and second posts and are fixably movable between a stowed position substantially parallel to the longitudinal axis of the rigid member and an extended position perpendicular or oblique to the longitudinal axis of the rigid member.

A third representative embodiment of the disclosure provides a work tool transportably received on a vehicle. The work tool includes a housing defining the outer volume of the power tool and a working member moveably mounted within the housing. A work surface is disposed upon the housing and a hinge is configured to be mounted to the housing and to a vehicle, the hinge configured to allow the housing to pivot with respect to the vehicle between a transport position and a work position.

Advantages of the present disclosure will become more apparent to those skilled in the art from the following description of the preferred embodiments of the invention that have been shown and described by way of illustration. As will be realized, the disclosure is capable of other and different embodiments, and its details are capable of modification in various respects. Accordingly, the drawings and description are to be regarded as illustrative in nature and not as restrictive.

### BRIEF DESCRIPTION OF SEVERAL VIEWS OF THE DRAWINGS

FIG. 1 is a front perspective view of a stand in an extended position.

FIG. 2 is a perspective view of the stand of FIG. 1.

FIG. 2a is another rear perspective view of the stand of FIG. 2 with a roller and leg installed.

FIG. 2b is an elevational view of the stand in a transport position and attached to a vehicle.

FIG. 3 is a front perspective view of the stand of FIG. 1 in a transport position.

FIG. 3a is a rear perspective view of an alternate stand in a transport position.

FIG. 4 is a rear perspective view of the stand of FIG. 3.

FIG. 4a is a perspective view showing the stand being attached to a vehicle.

FIG. 5 is a perspective view of a portable work tool in a use position.

FIG. 6 is the portable work tool of FIG. 5 in an intermediate position.

FIG. 7 is the portable work tool of FIG. 5 in a transport position.

FIG. 8 is a perspective view of the portable work tool of FIG. 5.

FIG. 9 is a perspective view of a cover for connection between a vehicle and the work tool of FIG. 5.

FIG. 10 is a perspective view of another portable work tool in a use position.

### DETAILED DESCRIPTION

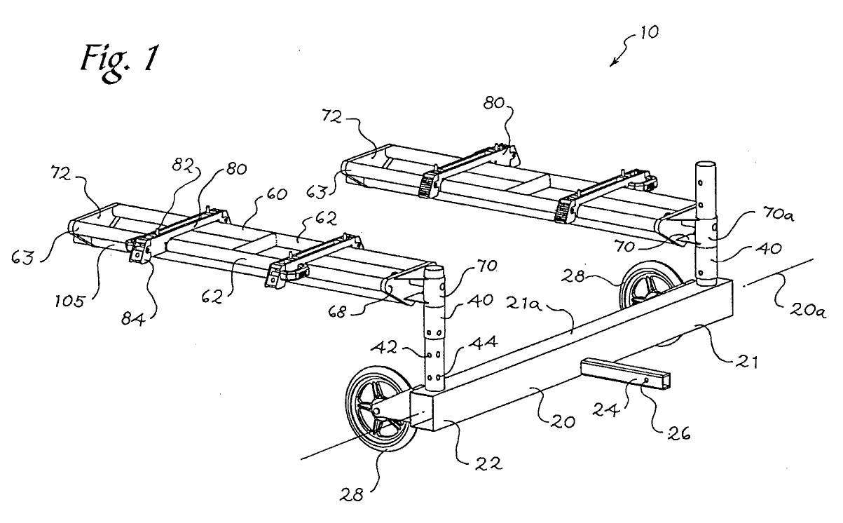

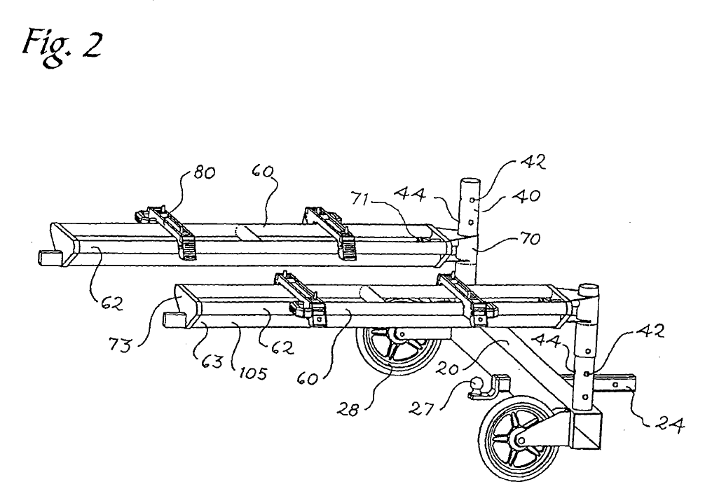

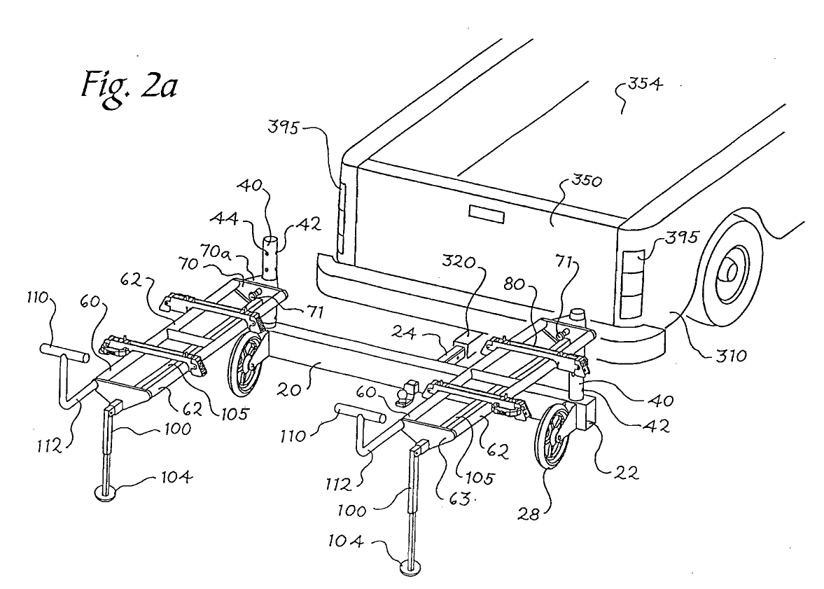

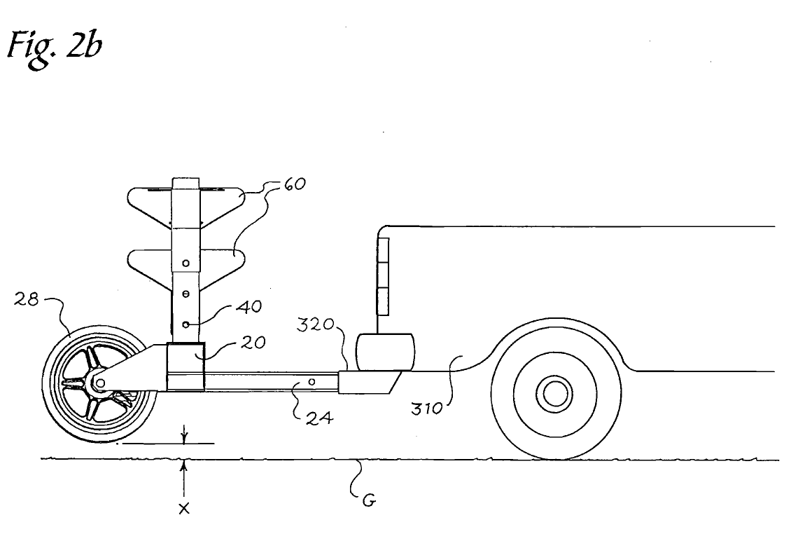

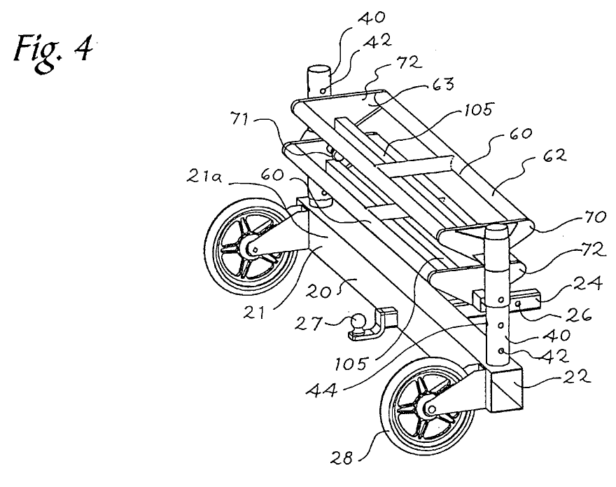

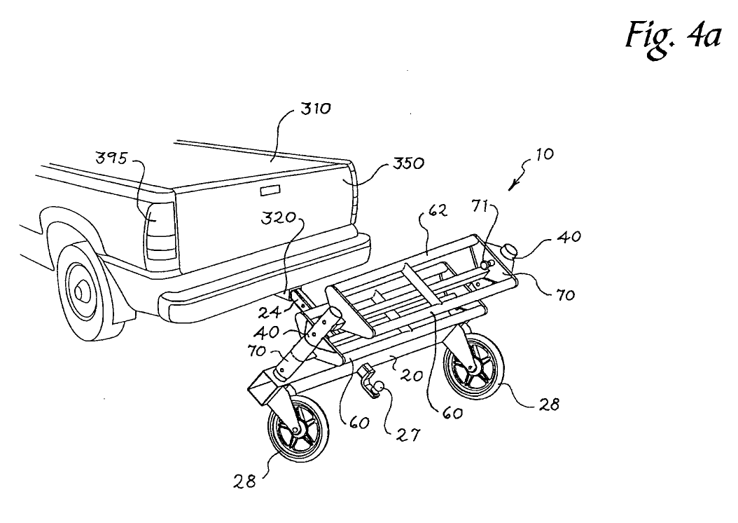

Turning now to FIGS. 1-4a, a portable stand 10 is provided. The portable stand 10 is configured to be removeably connectable to a vehicle 310 (shown in FIGS. 2b and 4a) to be transported therewith in a transport position (FIGS. 2b, 3-4) and can be selectively manipulated to place the stand 10 in a work position (FIG. 1-2a). The stand 10 includes a rigid member 20 that is removeably connectable with the vehicle 310, one or more posts 40 that extend substantially perpendicular to the rigid member 20, and one or more frames 60 that are rotatably and fixably mounted to one of the posts 40. Each of the one or more frames 60 is configured to removeably receive one or more brackets 80 that are each configured to receive a work tool thereupon. A suitable bracket 80 for receipt upon the frame 60 was disclosed in a pending utility patent application Ser. No. 11/679,461, filed on Feb. 27, 2007 and titled “Bracket,” which is commonly assigned to the assignee of the subject application and is fully incorporated by reference herein. In some embodiments, two or more brackets 80 are provided and each are lockingly engageable with the stand 60 to receive a work tool. In embodiments where two or more frames 60 may be provided with the stand 10, two or more brackets 80 are provided for each frame 60 to allow two or more work tools to be supported by the stand 10.

It is contemplated that the stand 10 may be configured to support a plurality of types of work tools, such as table saws, band saws, miter saws, planers, jig saws, drill presses, or other portable work tools that have a base or other component suitable to be removeably mounted to one or more brackets 80 on the stand 80, such as work surfaces.

The rigid member 20 may be an elongated column that extends along a longitudinal axis 20a between two extended ends 21, 22. A connector 24 is mounted to the rigid member 20 and extends substantially perpendicularly from a central portion of the rigid portion 20. The connector 24 may be an elongated member with a rectangular square profile or other geometrical profile that is configured to be inserted within a conventional trailer hitch receiver 320 (FIG. 4a) that is provided at a rear end of many vehicles, such as pickup trucks or SUVs. In other embodiments, the connector 24 may be configured to mate or connect with other types of hitches. The connector 24 may include one or more apertures 26 therein that are aligned to receive a pin (not shown) that may be extended through similar holes in the trailer hitch to securely connect the two devices. The connector 24 may be of a sufficient length to allow the connector 24 to be aligned with the trailer hitch when the wheels 28 of the stand 10 rest on the ground, as shown in FIG. 4a.

The rigid member 20 may include a trailer hitch 27, or secondary hitch receiver that extends from the opposite side of the rigid member 20 from which the connector 24 extends. The trailer hitch 27 may be a conventional trailer hitch that is configured to receive a structure similar to the connector 24 on a trailer for connection thereto. In other embodiments, the trailer hitch 27 may be a ball type hitch, as is known in the art. The trailer hitch 27 is configured to allow a trailer or similar structure to be rigidly connected with the stand 10 and therefore to the vehicle that the stand 10 is connected therewith.

The rigid member 20 additionally supports one or more wheels 28 that extend from the rigid member 20 substantially perpendicular to the longitudinal axis 20a of the rigid member 20. The wheels 28 are configured to not contact the ground when the stand 10 is connected to the vehicle (by way of the connection between the connector 24 and the trailer hitch receiver 320 of the vehicle), as shown in FIG. 2b. The wheels 28 remain a distance X off of the ground G when the stand is attached to the vehicle to allow the stand to clear most speedbumps, grooves, etc. that the vehicle may drive over with the stand attached thereto in the transport position. The wheels 28 are provided to allow the stand to be conveniently transported when disconnected from the vehicle.

The post 40 extends substantially perpendicularly from the rigid member 20, specifically from an end 21, 22 of the rigid member 20. In some embodiments, a post 40 is provided on each of the opposing ends 21, 22 of the rigid member 20. The post 40 may extend from the rigid member 20 relatively perpendicularly to the connector 24. The post 40 may include at least two sets of apertures 42, 44 that are disposed along the length of the posts 40.

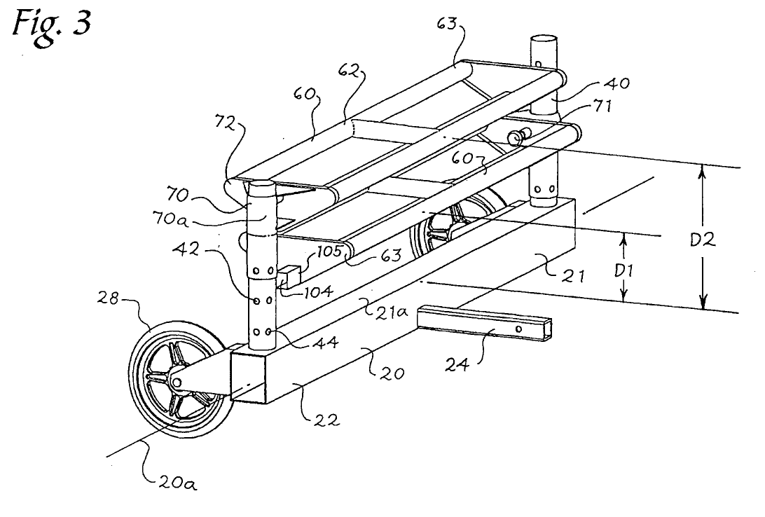

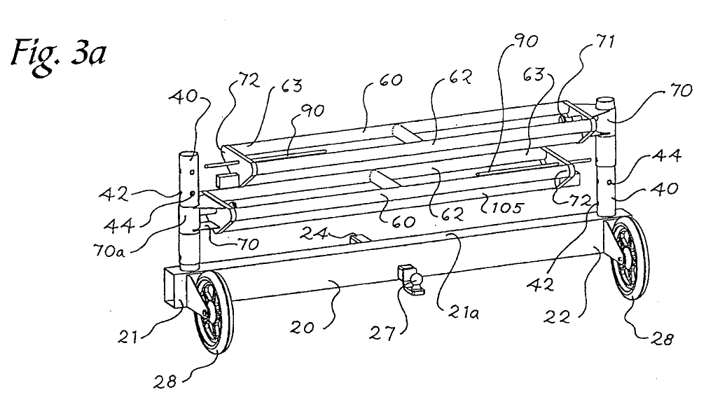

The first set of apertures 42 includes a plurality of apertures that are vertically disposed along the length of the post 40. The first set of apertures 42 are each aligned to be substantially parallel to the longitudinal axis 20a of the rigid member 20. The first set of apertures 42 are each disposed to assist in retaining the frame 60 in the transport position (FIGS. 3-4) by accepting a pin 71, or similar member such as a bar 90 discussed below, that extends from the frame 60 to retain the frame 60 at the selected rotational position and vertical position about the post 60. The first set of apertures 42 may be provided with consistent spacing along the length of the post 40, or in other embodiments, the first set of apertures 42 may be disposed at various positions along the length of the post 40 that are desired for retaining the frame 60 thereupon.

In embodiments including two or more posts 40, the frames 60 (discussed in detail below) may be disposed upon the respective posts 40 to engage different apertures of the first set of apertures 42 on each post 40 such that each frame 60 is at a different distance from the rigid member 20. For example, as shown in FIG. 3, a frame 60 attached to a post 40 proximate the first end 21 of the rigid member 20 may be disposed at a first distance D1 from the top surface 21a of the rigid member 20. Similarly, the frame 60 attached to a post 40 at the opposite second end 22 of the rigid member 20 may be disposed at a larger second distance D2 from the top surface 21a of the rigid member 20. The plurality of frames 60 are mounted to the respective post 40 such that each frame 60 is free to rotate to the transport position.

The second set of apertures 44 includes a plurality of apertures that are vertically disposed along the length of the post 40. The second set of apertures 44 may be each aligned to be substantially perpendicular to the longitudinal axis 20a of the rigid member 20. The second set of apertures 44 are each disposed to assist in retaining the frame 60 in the transport position (FIGS. 3-4) by accepting a pin 71, or similar member such as a bar 90 discussed below, that extends from the frame 60 to retain the frame 60 at the selected rotational position and vertical position about the post 60. In other embodiments, the second set of apertures 44 may be each aligned at an oblique angle with respect to the longitudinal axis 20a of the rigid member 20. In still other embodiments, multiple second sets of apertures 44 may be disposed upon the post 40, with the multiple sets each disposed at different oblique angles with respect to the longitudinal axis 20a of the rigid member 20, and one of the multiple second sets of apertures 44 may be disposed substantially perpendicularly to the longitudinal axis 20a of the rigid member 20.

Because there are a plurality of apertures that are vertically aligned to form the second set of apertures 44 on each post 40, the frame 60 may be disposed at differing heights above the vehicle 310 and above the ground to allow for the work tool to be ergonomically disposed for various worker heights and work processes. Similarly, each frame 60 may be mounted to the respective post 40 at a different height to allow a work tool that is disposed upon each frame 60 (with one or more mounting brackets 80) to be used and not interfere with each other.

The plurality of apertures forming each of the first and second sets of apertures 42, 44 are each configured to receive a pin or similar operator 71 (best shown in FIGS. 3-4) that is translatably retained on the collar 70 of the frame 60, discussed in further below. The pin 71 is biased toward the post 40 to slide within one aperture within the sets of apertures 42, 44 to fixedly retain the frame 60 at the selected rotational position and height upon the post 40. The pin 71 may be pulled away from the post 40 against a biasing force of a spring constrained with the pin 71 to withdraw the pin 71 form the aperture. When the pin 71 is withdrawn, the frame 60 is free to be rotated with respect to the post 40 and additionally free to be translated upward and downward along the length of the post 40. When the frame 60 is positioned at the desired location (whether in the transport position or the use position, the pin 71 is released and it enters one of the plurality of apertures if correctly aligned therewith.

The frame 60 is an elongate member, or a plurality of members retained together, that is rotatably mounted to the post 40 with a collar 70, as discussed above. The frame 60 may include two or more parallel beams 62 that are fixed together on each end with an end cap 72. On a first end of each beam 62, the end cap 72 may be connected to the collar 70. The parallel beams 62 may each be substantially cylindrical and include an outer surface that is configured to receive a removable bracket 80 thereupon. The beams 62 are configured to allow the bracket 80 to be received at a plurality of different locations along the length of the beams 62 to allow for positioning the work tool upon the bracket 80 at a plurality of different positions along the frame 60 and additionally to support a plurality of different types of work tools of different sizes, shapes, and configurations.

As discussed above, the frame 60 is supported by the post 40 with a collar 70. The frame 60 may extend from the post 40 in a cantilevered fashion, with the collar 70 providing the sole connection with the post 40. The collar 70 may include a hoop portion 70a with an inner diameter slightly larger than the outer diameter of the post 40 to allow the hoop portion 70a to slide along the length of the post 40. The pin 71 is movably connected to the collar 70 and biased outward into a position to extend within an aperture of the plurality of apertures 42, 44 to retain the frame 60 at the selected rotational and vertical position on the post 40.

As shown in FIG. 3a, in some embodiments that include two or more posts 40, the end cap 72 may support a second support, such as a translatable rod 90, that is selectively translatable along a portion of the length of the frame 60 to engage the opposing post 40 that is proximate the extended end 63 of the frame 60 when in the transport position (i.e. the post 40 opposite from the post 40 receiving the collar 70 of the frame 60). The rod 90 may be retained in a withdrawn position where the rod 90 does not extend substantially past the end cap 72, or may be translated to an extended position where the rod 90 extends beyond the end cap 72 to engage the opposing post 40. In some embodiments, the rod 90 is configured and movably mounted upon the frame 60 to be selectively insertable into one of the first set of apertures 42 on the post 40 when the frame 60 is in the transport position. As can be understood, the connection between the rod 90 and the opposite post 40 provides additional support for the frame 60 when in the transport position.

The frame 60 may additionally include a support leg 100 that provides support for the extended end 63 of the frame 60 when in the work position. The leg 100 may be movable between a stowed position (FIG. 4a) where the leg 100 does not substantially extend from the extended end 63 of the frame 60 to an extended position (FIG. 2b) where the leg 100 extends substantially perpendicularly from the extended end 63 of the frame 60 and contacts the ground. In some embodiments, the leg 100 may be telescopically extendable or retractable along its length to allow the foot 104 of the leg 100 to contact the ground when the frame 60 is mounted to various vertical positions of the post 40, i.e. when the frame 60 is connected to differing apertures of the second set of aperture 44. In some embodiments, the leg 100 may retract into a casing 105 fixed to the frame 60 when in the stowed position. The leg 100 may be withdrawn from the casing 105, rotated about the end cap 73 of the frame 60, telescopically extended to reach the ground, locked into position to support the extended end 63 of the frame 60. An exemplary design for the leg 100 is disclosed in copending application Ser. No. 11/679,530, titled “Foldable Stand for Supporting a Power Tool,” filed on Feb. 27, 2007, assigned to the assignee of the subject application, and is fully incorporated by reference herein. In other embodiments, the support leg 100 may be rotatably supported to the extended end 63 of the frame 60, and rotatable from a use position where the leg extends substantially perpendicular to the length of the frame 60 and a stowed position where the leg 100 is substantially parallel to the length of the frame 60.

The frame 60 may additionally be capable of receiving and supporting a roller support 110 from the extended end 63 of the frame 60. The frame 60 may include a second casing 106 that receives a bar 112 that extends perpendicularly from the roller support 110 to allow the roller support 110 to be removed from the frame 60 and installed and translated with respect to the frame 60 to selectively support different sized and shaped workpieces. In some embodiments, the bar 112 of the roller support 110 may be extended within the casing 105 that is configured to receive the leg 110 when the leg 100 is withdrawn from the casing 105. In other embodiments, the second casing 106 receiving the bar 112 may be one of the beams 62 that define the frame 60.

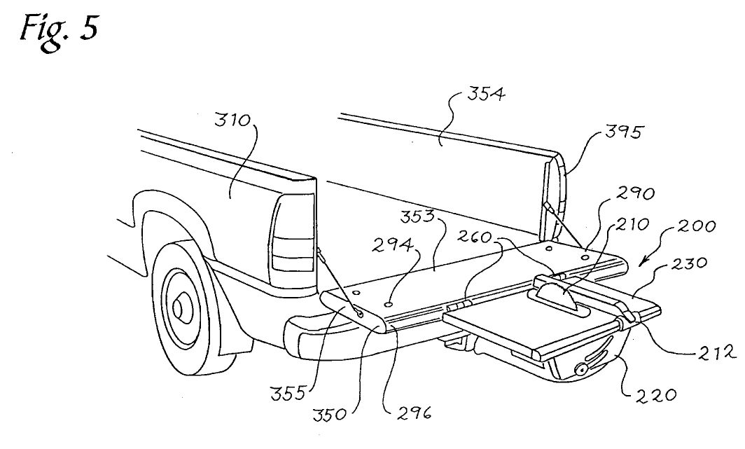

In some embodiments, the rigid member 20 and the posts 40 are configured to be attached to a vehicle by way of the connector 24 mating with a trailer hitch, with the posts 40 aligned outbound of a tailgate 350 (FIG. 5) to allow the tailgate 350 to freely rotate to an open position. Further, the stand 10 may be configured to be attachable to a vehicle in a way to prevent or minimize the obstruction of the lights 395 or other signaling devices at the rear of the vehicle 310.

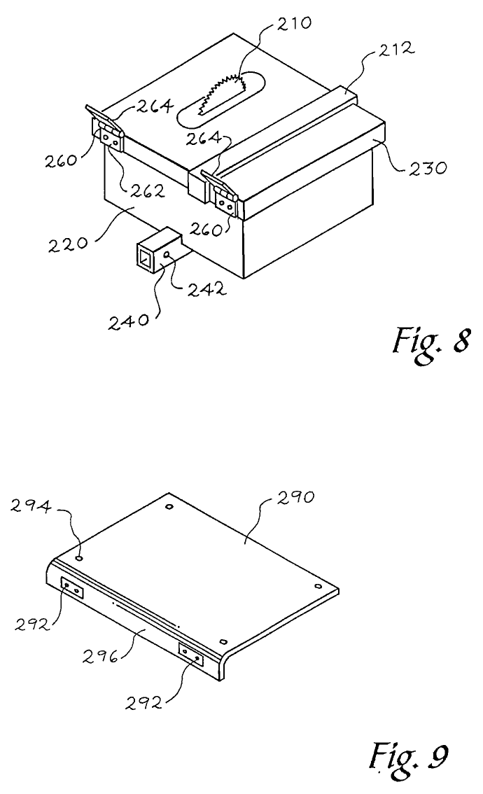

Turning now to FIGS. 5-9, another portable work tool 200 is provided. The portable work tool 200 is configured to be transported by a vehicle, such as a pickup truck. The portable stand 200 may be rotatably mounted to a tailgate 350 of a conventional pickup truck 310, or alternatively to another suitable portion of a vehicle. The portable work tool 200 includes a housing 220 that receives and stores the components found in a conventional work tool, such as a motor, transmission, saw blade, cutting blade or working member and suitable structural supports to support and enclose these elements.

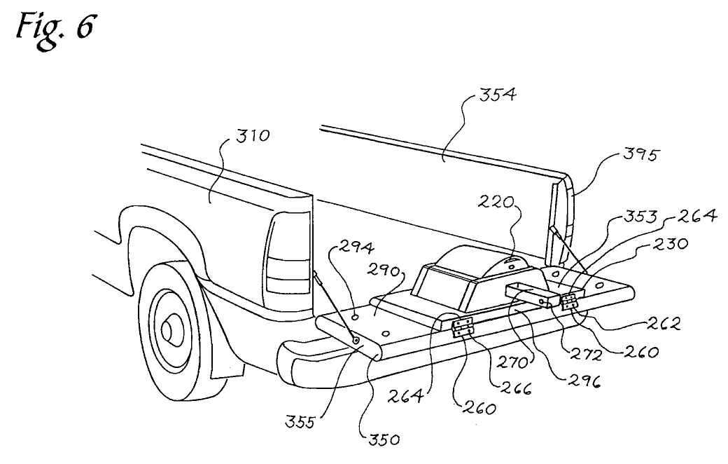

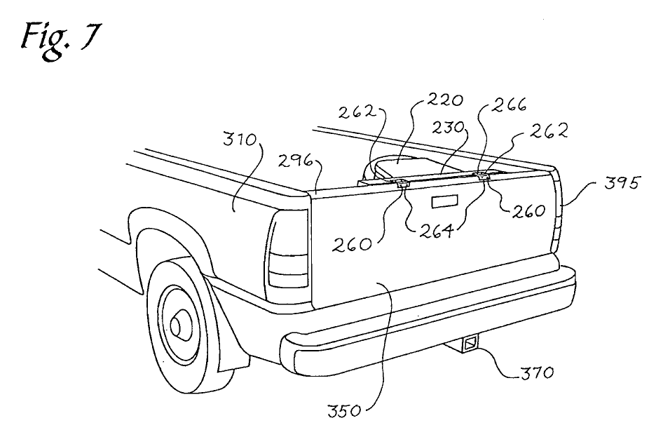

The portable work tool 200 further includes a work surface 230 that is disposed upon or above the housing 220, and one or more hinges 260. The portable work tool 200 is rotatably mounted to the vehicle 310 with one or more hinges 260 for rotation between a use position (FIG. 5) where the work surface 230 of the portable work tool 200 is exposed and the working member 210 is aligned to perform its designed function, and a transport position (FIG. 7) where the work surface 230 faces the tailgate 350 or another portion of the vehicle 310 and the housing 220 and tailgate 350 are stowed for vehicle motion. In embodiments where the work tool 200 is mounted to the tailgate 350 of a conventional pickup truck 310, the work tool 200 is further rotatable to an intermediate position (FIG. 6) between the use and transport positions, where the work surface 230 faces the inner surface of the tailgate 350 with the tailgate 350 disposed in an open position allowing access to the bed 354 of the truck 310.

As shown in FIG. 5, the work surface 230 extends outwardly from the tailgate when the work tool 200 is in the use position. In some embodiments, the work surface 230 faces in substantially the same upward direction as the inner surface 353 of the tailgate 350 when the work tool 200 is disposed in the use position. Further in some embodiments, the top surface of the work surface 230 is substantially planar with the inner surface 353 of the tailgate 350 and/or the floor of the bed 354 of the pickup truck 310. In this embodiment, an extended portion of a workpiece that is altered by the work tool 200 may rest flat on the inner surface 353 of the tailgate 350 and/or bed 354 to provide sufficient support to the workpiece for accurate and precise cuts or other activities thereon.

The hinges 260 each include first and second plates 262, 264 that are mounted to the work tool 200 and the vehicle 310, respectively. In some embodiments, the first plate 262 is rigidly mounted to one of the housing 220 or the work surface 230 and the second plate 264 is mounted upon or directly to the tailgate 350. The hinge plates 262, 264 may include one or more apertures 266 disposed within the hinge plates 262, 264 and accept fasteners to rigidly fix the respective hinge plate 262, 264 to the work tool 200 or the selected portion of the vehicle 310. The first and second plates 262, 264 can be shaped and configured as necessary to alter the relationship between two plates 262, 264 as the work tool 200 is rotated with respect to the tailgate 350, and the tailgate 350 is rotated with respect to the vehicle 310.

In some embodiments, the hinge plates 262, 264 are configured to be quickly disconnected from each other to allow for removal of the portable work tool 20 from the tailgate 350. The hinge plates 262, 264 may be rotatably mounted with a pin or with other structure that can be withdrawn or unhooked from the hinge plates 262, 264 to disconnect the plates.

In some embodiments, a cover 290 is provided to receive the second hinge plate 264. The cover 290 may be shaped in a plurality of orientations, but is configured to provide a suitable surface to securely receive the second hinge plate 264 and prevent the need to attach the second hinge plate 264 directly to the tailgate 350 or another portion of the vehicle. As shown in FIGS. 5-6 and 9, the cover 290 may be substantially “L” shaped to cover both the upper edge 352 of the tailgate 350 as well as the inner surface 353 of the tailgate 350. The cover 290 may be fixed to the tailgate 350 (or other suitable portion of the vehicle 310) with a plurality of fasteners, adhesive, or with other connection structures known in the art.

In some embodiments and as shown in FIG. 6, the work tool 200 is further supported upon the vehicle 310 with a connection between a trailer hitch receiver 320 on the vehicle 310 and a connector 270 that extends from the housing 220 of the work tool 200. The connector 270 may be a substantially rectangular member that is configured to slide within the trailer hitch receiver 320. The connector 270 may include one or more apertures 272 therein that are aligned to receive a pin (not shown) that may be extended through similar holes in the trailer hitch receiver 320 to rigidly connect the two devices. In some embodiments, the connector 270 may be telescopically mounted to the housing 220 to allow the connector 270 to extend from the housing 220 when the connector 270 and the trailer hitch receiver 320 are aligned, but allow clearance for the work tool 200 to be rotated about the tailgate 350 from the intermediate position to the work position.

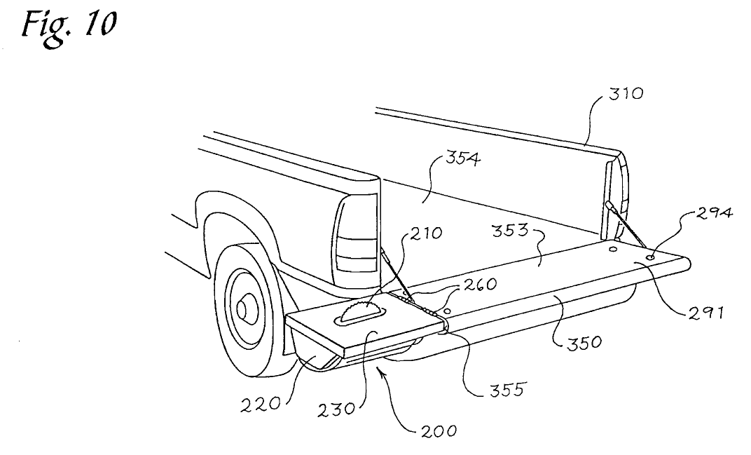

Turning now to FIG. 10, the work tool 200 may be mounted to the vehicle 310, and specifically one of the two side surfaces 355 of the tailgate 350. The connection between one of the side surfaces 355 of the tailgate 350 and the work tool 200 (specifically either the housing 220 or the work surface 230) allows for the tailgate 350 to function as a work table to retain the workpiece or other items associated with the task, while still allowing convenient access to the bed 354 of the vehicle 350. As shown in FIG. 10, the one or more hinges 260 are mounted to the side surface 355 of tailgate 350 (either directly or mounted to a cover 291 configured for side mounting, similar to the cover 290 discussed above), and is rotatable between the use position shown in FIG. 10, an intermediate position where the work surface 230 of the work tool 200 faces and is proximate the inner surface 353 of the tailgate 350 (similar to the intermediate position shown in FIG. 6) and a transport position (similar to the transport position shown in FIG. 7) where the tailgate 350 is rotated to the closed position.

The foregoing disclosure is the best mode devised by the inventors for practicing this disclosure. It is apparent, however, that apparatus incorporating modifications and variations will be obvious to one skilled in the art. Inasmuch as the foregoing disclosure is intended to enable one skilled in the pertinent art to practice the instant disclosure, it should not be construed to be limited thereby but should be construed to include aforementioned obvious variations and be limited only by the spirit and scope of the following claims.

It is therefore intended that the foregoing detailed description be regarded as illustrative rather than limiting, and that it be understood that it is the following claims, including all equivalents, that are intended to define the spirit and scope of this disclosure.

1. A portable stand for a tool comprising:
a rigid member with a longitudinal axis and a connector configured to be releasably mounted to a vehicle;
a first post extending from the rigid member;
a frame rotatably connected with the first post and fixable with respect to the first post in a plurality of discrete positions; and
a mounting bracket that is lockingly engageable with the frame and configured to fixedly support a work tool.

2. The portable stand of claim 1, wherein the frame is fixable in a first position substantially parallel to the longitudinal axis of the rigid member and fixable in a second position perpendicular or oblique to the longitudinal axis.

3. The portable stand of claim 2, wherein the first frame is supported in a cantilevered manner upon the first post in both of the first and second positions.

4. The portable stand of claim 1, further comprising a second post extending from the rigid member parallel to the first post, and a second frame pivotably connected with the second post and fixable with respect to the second post in a plurality of different positions.

5. The portable stand of claim 4, wherein the second frame is fixable in a first position substantially parallel to the longitudinal axis of the rigid member and to a second position perpendicular or oblique to the longitudinal axis.

6. The portable stand of claim 4, wherein the first frame is connected to the first post at a first distance from a top surface of the rigid member and the second frame is connected to the second post at a second larger distance from the top surface of the rigid member.

7. The portable stand of claim 4, wherein the first and second frames are each fixable with respect to the respective first and second posts in a substantially overlapping and parallel fashion.

8. The portable stand of claim 7, wherein the first and second frames are each fixable in a second position with respect to the respective first and second posts with each of the first and second frames being substantially perpendicular to the longitudinal axis of the rigid member and substantially parallel to each other.

9. The portable stand of claim 1, wherein the connector is beam extending from the rigid member and configured to be fixedly mounted to a vehicle hitch.

10. The portable stand of claim 1, further comprising a second mounting bracket that is lockingly engageable with the frame and configured to fixedly support a power tool in conjunction with the mounting bracket.

11. The portable stand of claim 4, further comprising a second mounting bracket that is lockingly engageable with the second frame and configured to fixedly support a second work tool upon the second frame.

12. The portable stand of claim 1, further comprising a plurality of wheels rotatably mounted to the rigid member and configured to allow the stand to be transported when not mounted to the vehicle.

13. The portable stand of claim 2, wherein the frame comprises a leg movably connected to an extended end of the frame to support the frame in an extended position.

14. The portable stand of claim 13, wherein the leg is rotatably connected to the extended end of the frame, and rotatable between an extended position substantially parallel with the post and a stowed position substantially perpendicular to the post.

15. A portable stand for a tool, comprising:
a rigid member with a longitudinal axis, the rigid member further comprising a connector for selective releasable connection with a vehicle, a plurality of wheels rotatably mounted to the rigid member, and configured to allow the stand to be transported when not mounted to the vehicle;
a first post and a second post that each extend substantially perpendicularly from opposite ends of the rigid member;
a first frame and a second frame each mounted to the respective first and second posts and fixably movable between a stowed position substantially parallel to the longitudinal axis of the rigid member and an extended position perpendicular or oblique to the longitudinal axis of the rigid member.

16. The stand of claim 15, wherein each of the first and second frames are mounted to the respective first and second posts at respective different distances from a top surface of the rigid member when each of the first and second frames are in the stowed position.

17. The stand of claim 16, wherein each of the first and second frames are adjustably mounted to the respective first and second posts to allow for a plurality of different distances between each of the first and second frames and the top surface of the rigid member when in the stowed position.

18. The stand of claim 15, further comprising a mounting bracket that is engageable with one or both of the first and second frames.

19. The stand of claim 18, wherein the mounting bracket is configured to receive and fixedly support a work tool.

20. A work tool transportably received on a vehicle, comprising:
a housing defining the outer volume of the power tool;
a working member moveably mounted within the housing;
a work surface disposed upon the housing;
a hinge configured to be mounted to the housing and to a vehicle, the hinge configured to allow the housing to pivot with respect to the vehicle between a transport position and a work position.

21. The power tool of claim 20, wherein the hinge is configured to be rotatably mounted to a rotatable tailgate of a vehicle.

22. The power tool of claim 21, wherein the work surface of the housing faces an inner surface of the tailgate when the housing is in the transport position and the work surface extends outwardly from the tailgate when the housing is in the work position.

23. The power tool of claim 21, wherein the work surface of the housing and an inner surface of the tailgate face the same general direction when the housing is in the work position and the work surface faces the inner surface of the tailgate when the housing is in the transport position.

24. The power tool of claim 21, further comprising a cover fixably connectable with the tailgate and configured to receive the hinge.

25. The power tool of claim 25, further comprising a connector mounted to the housing and configured to engage a hitch of the vehicle when the housing is in work position.
